(19) United States
(12) Patent Application Publication
(10) Pub. No.: US 2019/0223192 A1
(43) Pub. Date: Jul. 18, 2019

(54) TIME SLOT REASSIGNMENT MECHANISM FOR RADIO ACCESS TECHNOLOGY COEXISTENCE IMPROVEMENT

(71) Applicant: QUALCOMM Incorporated, San Diego, CA (US)

(72) Inventor: Joel LINSKY, San Diego, CA (US)

(21) Appl. No.: 15/870,017

(22) Filed: Jan. 12, 2018

(51) Int. Cl. H04W 72/12; H04W 72/04; H04R 3/00; H04R 1/10

(52) U.S. Cl. CPC H04W 72/1215; H04W 72/0446; H04W 84/12; H04R 1/1016; H04R 1/1041; H04R 3/005

(57) ABSTRACT

In an aspect of the disclosure, a method, a computer-readable medium, and an apparatus are provided. The apparatus may employ a time slot reassignment mechanism that increases the throughput of a second RAT by reducing the number of consecutive time slots assigned for a first RAT without reducing the throughput of the first RAT.

### BACKGROUND

### Field

The present disclosure relates generally to communication systems, and more particularly, to a time slot reassignment mechanism that increases the throughput of a second radio access technology (RAT) by reducing the number of consecutive time slots assigned for a first RAT without reducing the throughput of the first RAT.

### Background

A wireless personal area network (WPAN) is a personal, short-range wireless network for interconnecting devices centered around a specific distance from a user. Wireless personal area networks (WPANs) have gained popularity because of the flexibility and convenience in connectivity that WPANs provide. WPANs are based on short-range communication technology (e.g., a Bluetooth® (BT) protocol, a Zigbee® protocol, etc.), and provide short-range wireless links that allow connectivity within a specific distance (e.g., 5 meters, 10 meter, 20 meters, 100 meters, etc.) from a master device. In contrast to WPAN systems, wireless local area networks (WLANs) provide connectivity to devices that are located within a larger geographical area, such as the area covered by a building or a campus, for example. WLANs are typically based on a IEEE 802.11 protocol (e.g., Wi-Fi protocol), typically operate within a 100-meter or greater than 100-meter range, and are generally utilized to supplement the communication capacity provided by traditional wired local area networks (LANs) installed in the same geographic area as the WLAN. In some instances, WLANs may operate in conjunction with WPANs to provide users with an enhanced overall functionality.

Thus, a wireless device may have multiple radio interfaces that support multiple radio access technologies (RATs) as defined by various wireless communication protocols (e.g., Wi-Fi, BT, etc.). Accordingly, a wireless device may concurrently operate multiple radio interfaces corresponding to multiple RATs (e.g., Wi-Fi, BT, etc.).

There is a need to increase the throughput of various RATs that are concurrently operated by a wireless device.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

A wireless device may have multiple radio interfaces that support multiple RATs as defined by specific wireless communication protocols (e.g., Wi-Fi, BT, etc.). Accordingly, a wireless device may concurrently operate multiple radio interfaces corresponding to multiple RATs, such as BT and Wi-Fi.

A BT radio interface (e.g., a BT controller) located at the wireless device may implement a BT protocol that supports synchronous logical transport mechanisms that exist between a master device and a slave device. One example of a synchronous logical transport mechanism is a synchronous connection oriented (SCO) logical transport. An SCO logical transport may provide a symmetric point-to-point link (an SCO link) between a master device and a slave device using time slots reserved for BT communications. An SCO link may not support data packet retransmission, however. Data packet retransmission may be useful in audio streaming and/or a voice use cases because a dropped audio or voice packet may reduce the quality of the user experience. Hence, using an SCO link may be impractical in audio streaming and/or voice use cases.

Additionally and/or alternatively, the BT protocol implemented by the BT radio interface may support an extended synchronous connection oriented (eSCO) logical transport. An eSCO logical transport may provide a symmetric or asymmetric point-to-point link (an eSCO link) between a master device and a slave device using time slots reserved for BT communications, and also provide a retransmission window following the reserved time slots. Because retransmissions may be facilitated using the retransmission window, an eSCO link may be useful in audio streaming and/or voice use cases because a dropped audio or voice packet may be retransmitted, and hence, the probability of properly receiving a dropped data packet may be increased.

During silent unreserved time slots (which are outside the retransmission window) and/or unused retransmission slots (which can be thought of as opportunistic for both Bluetooth and Wi-Fi), a Wi-Fi radio interface (e.g., a WLAN controller) at the wireless device may share the same frequency bandwidth as the BT radio interface, and for established SCO and/or eSCO links, both the master device and the slave device may have knowledge of which time slots are reserved for BT and which time slots are unreserved for BT (e.g., unoccupied by BT packet data). Consequently, communications by the Wi-Fi radio interface may avoid interference with BT communications via the SCO link and/or eSCO link by using the unoccupied time slots for Wi-Fi communications. However, as the number of consecutive time slots reserved for BT communications increases, the throughput for Wi-Fi communications may be reduced (e.g., exponentially reduced).

In configurations when the slave device includes a microphone, certain time slots may be reserved for a BT microphone path between the master device and the slave device and different time slots may be reserved for a BT audio path between the master device and the slave device. When the slave device includes a pair of true-wireless stereo (TWS) earbuds, a first eSCO link may be used for BT communications between a first TWS earbud and the master device, and a second eSCO link may be used for BT communications between the second TWS earbud and the master device.

In certain configurations, respective BT audio time slots associated with the first eSCO link and the second eSCO link may be used to carry BT audio data that is output at both the first TWS earbud and the second TWS earbud. However, BT microphone time slots associated with one of the first eSCO link or the second eSCO link (but not both) may be used to carry BT microphone packet data to the master device, and the BT microphone time slots associated with the other one of the first eSCO link or the second eSCO link may be muted (e.g., unused) in order to reduce power consumption at the master device and/or the slave device.

In other words, the unused BT microphone time slots in either the first eSCO link or the second eSCO link may be intentionally dropped by the master device. Even though the BT microphone time slots of one of the eSCO links remain unused, the unused BT microphone time slots are still reserved for BT communications, and hence, may be unavailable for Wi-Fi communications, thereby reducing Wi-Fi throughput without increasing BT throughput.

Thus, there is a need for a mechanism that increases Wi-Fi throughput without reducing BT throughput in a wireless device.

The present disclosure provides a solution by assigning the unused microphone time slots associated with one of the eSCO links for Wi-Fi communications when the slave device includes a pair of TWS earbuds, thereby increasing the number of consecutive time slots available for Wi-Fi communications without reducing BT throughput.

In an aspect of the disclosure, a method, a computer-readable medium, and an apparatus are provided. The apparatus may be a master device. The apparatus may establish a first communication link with a first slave device and a second communication link with a second slave device. In certain aspects, the first communication link and the second communication link may be associated with a first RAT, and the first slave device and the second slave device may form a device pair (e.g., a pair of TWS earbuds). The apparatus may assign a first set of slots to the first slave device for communications with the master device via the first communication link. In certain aspects, the first set of slots may include a first microphone slot. The apparatus may assign a second set of slots to the second slave device for communication with the master device via the second communication link. In certain aspects, the second set of slots may be located subsequent to the first set of slots in the time domain, and the second set of slots may include a second microphone slot. The apparatus may assign the first microphone slot in the first set of slots as a microphone path from the device pair to the first slave device. The apparatus may assign the second microphone slot in the second set of slots to a second RAT. The apparatus may communicate with at least one third device using a second RAT in the second microphone slot in the second set of slots, the second RAT being different than the first RAT.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a WPAN and WLAN.

FIG. 2 is block diagram of a wireless device in accordance with certain aspects of the disclosure.

FIG. 3 is a diagram illustrating a BT protocol stack that may be implemented in a wireless device in accordance with certain aspects of the disclosure.

FIG. 4 is a diagram illustrating time slots that may be reserved by a master device for a first eSCO link with a first slave device and a second eSCO link with a second slave device in accordance with certain aspects of the disclosure.

FIG. 5 is a data flow that may be used by a master device to increase the throughput of a first RAT in a multiple RAT system without reducing the throughput of a second RAT in accordance with certain aspects of the disclosure.

FIG. 6 is a flowchart of a method of wireless communication.

FIG. 7 is a conceptual data flow diagram illustrating the data flow between different means/components in an exemplary apparatus.

FIG. 8 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. The apparatus and methods will be described in the following detailed description and illustrated in the accompanying drawings by various blocks, components, circuits, processes, algorithms, etc. (collectively referred to as “elements”). The elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

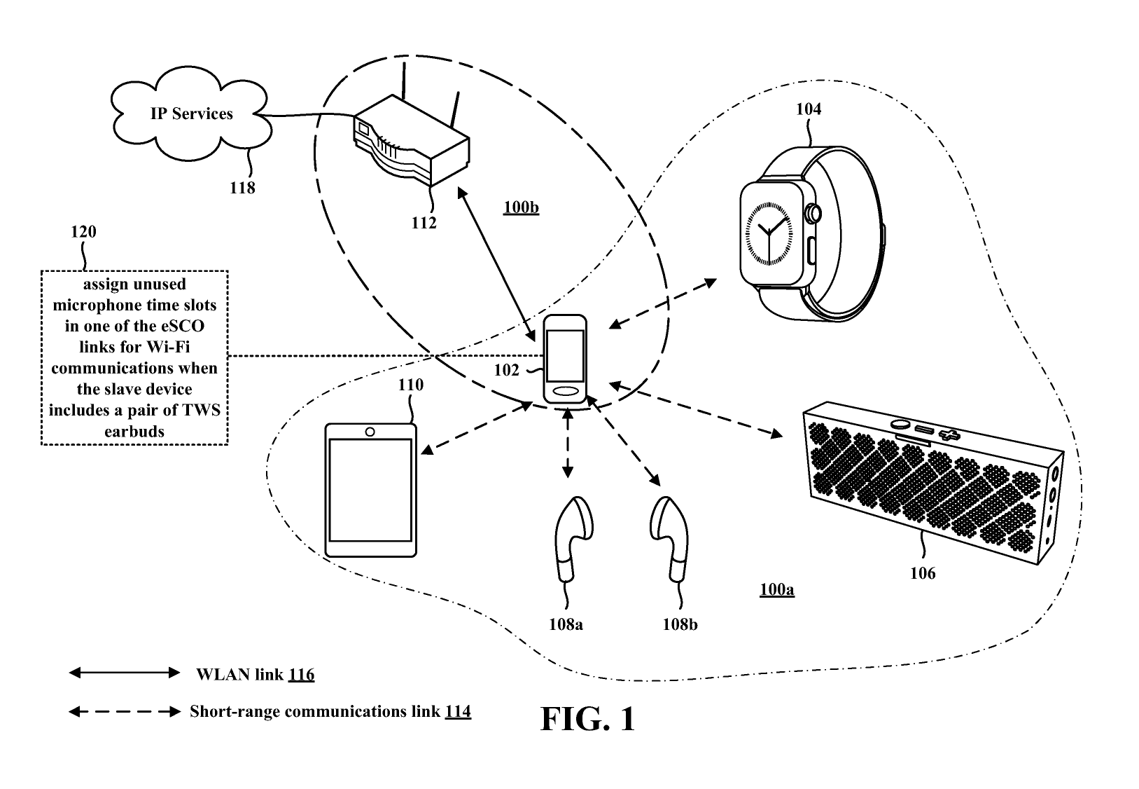

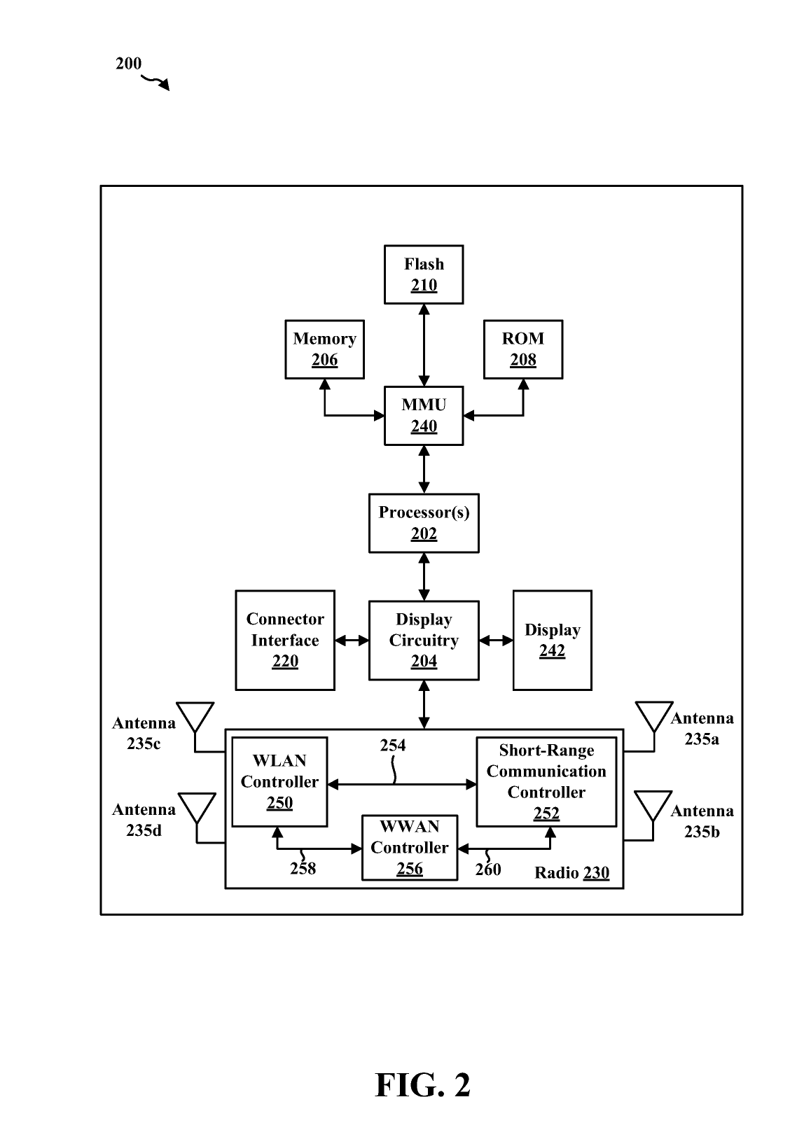

FIG. 1 illustrates an example WPAN 100a and a WLAN 100b in accordance with certain aspects of the disclosure. A master device 102 may be part of both the WPAN 100a and the WLAN 100b, and thus be configured to operate multiple radio interfaces corresponding to multiple RATs (e.g., Wi-Fi, BT, Bluetooth Low Energy (BLE) etc.) concurrently. For example, a BT radio interface at the master device 102 may be used for communications within the WPAN 100a, and a Wi-Fi radio interface at the master device 102 may be used for communications within the WLAN 100b. Shared antennas for different RATs may be used by the master device 102, e.g., as discussed below with reference to FIG. 2. The shared antennas may be used for, e.g., short-range communications via a short-range communication link 114 (e.g., SCO link, eSCO link, etc.) and Wi-Fi communications via a WLAN link 116. In certain aspects, the short-range communications and Wi-Fi communications may be performed using the same frequency band (e.g., 2.4-2.4835 GHz frequency range, 5 GHz frequency range, etc.). In certain other aspects, the short-range communications and Wi-Fi communications may be performed using different frequency bands.

Examples of the master device 102 include a cellular phone, a smart phone, a session initiation protocol (SIP) phone, a mobile station (STA), a laptop computer, a personal computer (PC), a desktop computer, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a toaster, or any other similarly functioning device.

Within the WPAN 100a, the master device 102 may communicate with one or more slave devices 104, 106, 108a, 108b, 110 using a short-range communications protocol (e.g., BT protocol, BLE protocol, Zigbee® protocol, etc.). Examples of the one or more slave devices 104, 106, 108a, 108b, 110 may include a pair of wireless earbuds (e.g., TWS earbuds), a cellular phone, a smart phone, a SIP phone, a STA, a laptop, a PC, a desktop computer, a PDA, a satellite radio, a global positioning system, a multimedia device, a video device, a digital audio player (e.g., MP3 player), a camera, a game console, a tablet, a smart device, a wearable device such as a smart watch or wireless headphones, a vehicle, an electric meter, a gas pump, a toaster, or any other similarly functioning device. Although the master device 102 is illustrated in communication with five slave devices 104, 106, 108a, 108b, 110 in the WPAN 100a, the master device 102 may communicate with more or fewer than five slave devices within the WPAN 100a without departing from the scope of the present disclosure.

Within the WLAN 100b, the master device 102 may communicate with at least one second device 112 using a Wi-Fi communications protocol (e.g., IEEE 802.11 protocol, etc.). The second device 112 may be configured to connect to Internet Protocol (IP) Services 118. The IP Services 118 may include the Internet, an intranet, an IP Multimedia Subsystem (IMS), a PS Streaming Service, and/or other IP services. The second device 112 may communicate information between the master device 102 and IP Services 118. Examples of the second device 112 include a Wi-Fi router and/or a Wi-Fi AP. Wi-Fi communications may be performed using time slots in the 5 GHz unlicensed spectrum that are not reserved for BT communications or a BT retransmission window. When communicating in an unlicensed frequency spectrum, the master device 102 and/or the second device 112 may perform a clear channel assessment (CCA) prior to communicating with one another in order to determine whether the channel is available.

Referring again to FIG. 1, in certain aspects, the master device 102 may be configured to assign unused microphone time slots associated with a short-range communication link 114 (e.g., eSCO link) for Wi-Fi communications when the slave devices 108a, 108b includes a pair of TWS earbuds (120).

FIG. 2 is block diagram of a wireless device 200 in accordance with certain aspects of the disclosure. The wireless device 200 may correspond to, e.g., the master device 102, and/or one of the slave devices 104, 106, 108a, 108b, 110, 112 described above in connection with FIG. 1. In certain aspects, the wireless device 200 may be a short-range communication enabled and a Wi-Fi enabled device such as a smart phone that is configured to communicate with TWS wireless earbuds using separate eSCO links and with another device using a Wi-Fi link.

As shown in FIG. 2, the wireless device 200 may include a processing element, such as processor(s) 202, which may execute program instructions for the wireless device 200. The wireless device 200 may also include display circuitry 204 which may perform graphics processing and provide display signals to the display 242. The processor(s) 202 may also be coupled to a memory management unit (MMU) 240, which may be configured to receive addresses from the processor(s) 202 and translate the addresses to address locations in memory (e.g., memory 206, ROM 208, Flash memory 210) and/or to address locations in other circuits or devices, such as the display circuitry 204, radio 230, connector interface 220, and/or display 242. The MMU 240 may be configured to perform memory protection and page table translation or set up. In some embodiments, the MMU 240 may be included as a portion of the processor(s) 202. In certain configurations, one or more of the processor(s) 202, memory 206, ROM 208, and/or Flash memory 210 may be configured to assign unused microphone time slots associated with one eSCO link in a pair of eSCO links for Wi-Fi communications when the slave device includes a pair of TWS earbuds.

As shown, the processor(s) 202 may be coupled to various other circuits of the wireless device 200. For example, the wireless device 200 may include various types of memory, a connector interface 220 (e.g., for coupling to the computer system), the display 242, and wireless communication circuitry (e.g., for Wi-Fi, BT, BLE, cellular, etc.). The wireless device 200 may include a plurality of antennas 235a, 235b, 235c, 235d, for performing wireless communication with, e.g., a first set of wireless devices in a WPAN and a second set of wireless devices in a WLAN.

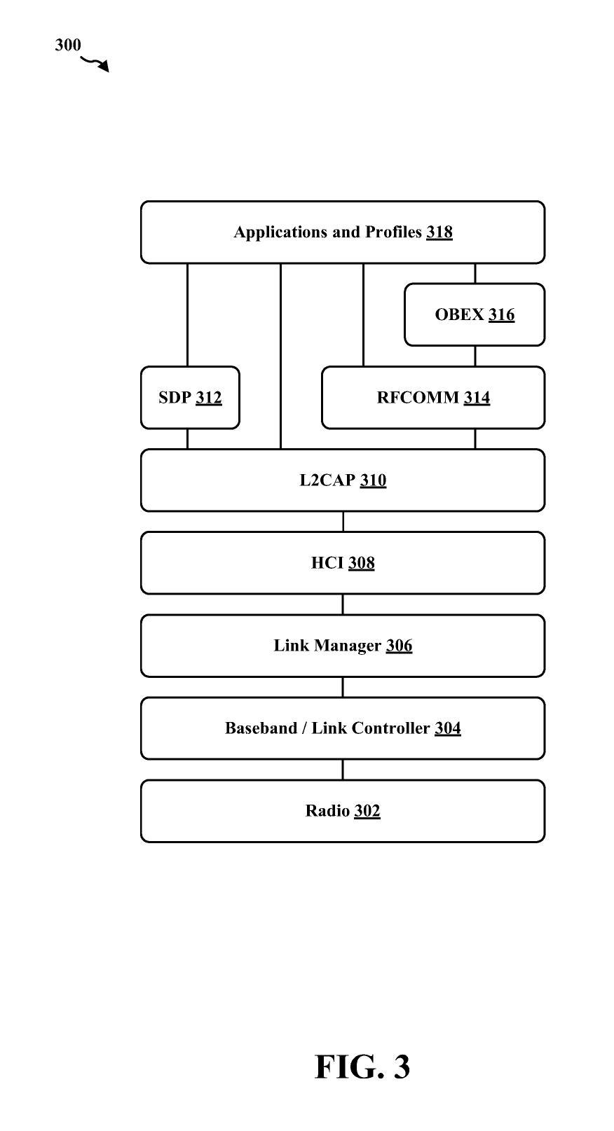

In certain aspects, the wireless device 200 may include hardware and software components (a processing element) configured to assign unused microphone time slots associated with one eSCO link in a pair of eSCO links for Wi-Fi communications when the slave device includes a pair of TWS earbuds, e.g., using the techniques described below in connection with any FIGS. 3-8. The wireless device 200 may also comprise BT firmware or other hardware/software for controlling BT operations, e.g., such as assigning microphone time slots and/or audio time slots.

The wireless device 200 may be configured to implement part or all of the techniques described below in connection with any of FIGS. 3-8, e.g., by executing program instructions stored on a memory medium (e.g., a non-transitory computer-readable memory medium) and/or through hardware or firmware operation. In other embodiments, the techniques described below in connection with any of FIGS. 3-8 may be at least partially implemented by a programmable hardware element, such as an field programmable gate array (FPGA), and/or an application specific integrated circuit (ASIC).

In certain aspects, radio 230 may include separate controllers (e.g., radio interfaces) configured to control communications for various respective RAT protocols. For example, as shown in FIG. 2, radio 230 may include a WLAN controller 250 (e.g., a Wi-Fi radio interface) configured to control WLAN communications, a short-range communication controller 252 (e.g., a BT radio interface) configured to control short-range communications, and a WWAN controller 256 (e.g., cellular radio interface) configured to control WWAN communications. In certain aspects, the wireless device 200 may store and execute a WLAN software driver for controlling WLAN operations performed by the WLAN controller 250, a short-range communication software driver for controlling short-range communication operations performed by the short-range communication controller 252, and/or a WWAN software driver for controlling WWAN operations performed by the WWAN controller 256.

In certain implementations, a first coexistence interface 254 (e.g., a wired interface) may be used for sending information between the WLAN controller 250 and the short-range communication controller 252. In certain other implementations, a second coexistence interface 258 may be used for sending information between the WLAN controller 250 and the WWAN controller 256. In certain other implementations, a third coexistence interface 260 may be used for sending information between the short-range communication controller 252 and the WWAN controller 256.

In some aspects, one or more of the WLAN controller 250, the short-range communication controller 252, and/or the WWAN controller 256 may be implemented as hardware, software, firmware or some combination thereof.

In certain configurations, the WLAN controller 250 may be configured to communicate with a device in a WLAN via a WLAN link using all of the antennas 235a, 235b, 235c, 235d. In certain other configurations, the short-range communication controller 252 may be configured to communicate with at least one slave device in a WPAN via an eSCO link using one or more of the antennas 235a, 235b, 235c, 235d. In certain other configurations, the WWAN controller 256 may be configured to communicate with a device in a WWAN via a cellular link using all of the antennas 235a, 235b, 235c, 235d. The WLAN controller 250 and/or short-range communication controller 252 may be configured to assign unused microphone time slots associated with one eSCO link in a pair of eSCO links for Wi-Fi communications when the slave device includes a pair of TWS earbuds, e.g., as described below in connection with any of FIGS. 3-8.

FIG. 3 illustrates a BT protocol stack 300 that may be implemented in a wireless device in accordance with certain aspects of the disclosure. For example, the BT protocol stack 300 may be implemented by, e.g., one or more of processor(s) 202, memory 206, Flash memory 210, ROM 208, the radio 230, the WLAN controller 250, and/or the short-range communication controller 252 illustrated in FIG. 2.

Referring to FIG. 3, the BT protocol stack 300 may be organized into lower layers, a host-controller interface (HCI) 308, and upper layers. The lower layers of the BT protocol stack 300 may include a radio layer 302, a baseband/link controller layer 304, and a link manager 306. The upper layers of the BT protocol stack 300 may include a Logical Link Control and Adaptation Protocol (L2CAP) layer 310, a service discovery protocol (SDP) layer 312, a radio frequency communication (RFCOMM) layer 314, an object exchange (OBEX) layer 316, and an applications and profiles layer 318.

At the base of the BT protocol stack 300 is the radio layer 302. The radio component (e.g., radio 230 in FIG. 2) in a wireless device may be responsible for the modulation and demodulation of data into radio frequency (RF) signals for transmission over the air. The radio layer 302 may describe the physical characteristics of a wireless device's receiver/transmitter. The physical characteristics may include modulation characteristics, radio frequency tolerance, sensitivity level, etc.

Above the radio layer 302 is the baseband and link controller layer 304. In certain configurations, the baseband portion of the baseband and link controller layer 304 may be responsible for properly formatting data for transmission to and from the radio layer 302, and for synchronization of links (e.g., SCO links, eSCO links, asynchronous connectionless (ACL) links, etc.). The link controller portion of the baseband and link controller layer 304 may be responsible for carrying out the link manager's 306 commands and establishing and maintaining the link stipulated by the link manager 306.

The link manager 306 may translate HCI 308 commands into baseband-level operations, and may be responsible for establishing and configuring links and managing power-change requests, among other tasks. Each type of link (e.g., SCO links, eSCO links, ACL links, etc.) may be associated with a specific packet type. An SCO link may provide reserved channel bandwidth for communication between a master device and a slave device, and support regular, periodic exchange of data packets with no retransmissions. An eSCO link may provide reserved channel bandwidth for communication between a master device and a slave device, and support regular, periodic exchange of data packets with retransmissions. An ACL link may exist between a master device and a slave device the moment a connection is established. The data packets for ACL links may include encoding information in addition to a payload.

The HCI 308 layer may act as a boundary between the lower layers of the BT protocol stack 300 and the upper layers. The BT specification may define a standard HCI to support BT systems that are implemented across two separate processors. For example, a BT system on a computer might use a BT component's processor to implement the lower layers of the stack (radio layer 302, baseband and link controller layer 304, and link manager 306). The BT system might then use the BT system's own processor to implement the upper layers (L2CAP layer 310, SDP layer 312, RFCOMM layer 314, OBEX layer 316, and applications and profiles layer 318). Here, the lower portion may be referred to as the BT component and the upper portion as the BT host.

The L2CAP layer 310 is located above the HCI 308. The L2CAP layer 310 is primarily responsible for establishing connections across existing ACL links or requesting an ACL link if one does not already exist, multiplexing between different higher layer protocols, such as SDP protocols and RFCOMM protocols, to allow different applications to use a single ACL link, and repackaging the data packets received from the higher layers into the form expected by the lower layers. The L2CAP layer 310 may employ the concept of channels to keep track of where data packets come from and where data packets should go. A channel may be a logical representation of the data flow between the L2CAP layer 310 at a master device and an L2CAP layer 310 at a slave device.

The SDP layer 312 may define actions for both servers and clients of BT services. The BT specification defines a service as any feature that may be usable by another (remote) BT device. An SDP client may communicate with an SDP server using a reserved channel on an L2CAP link to discover what services are available. When the SDP client finds the desired service, the SDP client may request a separate connection to use the service. The reserved channel may be dedicated to SDP communication so that a device knows how to connect to the SDP service on any other device. An SDP server may maintains an SDP database, which is a set of service records that describe the services the SDP server offers. Along with information describing how an SDP client can connect to the service, the service records may contain the service's universally unique identifier (UUID).

The RFCOMM layer 314 may emulate the serial cable line settings and status of an RS-232 serial port. The RFCOMM layer 314 may connect to the lower layers of the BT protocol stack 300 through the L2CAP layer 310. By providing serial-port emulation, the RFCOMM layer 314 may support legacy serial-port applications. The RFCOMM layer 314 may also support the OBEX layer 316 discussed below.

The OBEX layer 316 may define data objects and a communication protocol two devices use to exchange the defined data objects. A BT device that wants to set up an OBEX communication session with another device may be considered the client device. The client initially sends one or more SDP requests to ensure that the other device can act as a server of OBEX services. If the server device can provide OBEX services, the server device may respond with the OBEX service record of the server device. The OBEX service record may contain the RFCOMM channel number the client device may use to establish an RFCOMM channel. Further communication between the two devices may be conveyed in packets, which may contain requests, responses, and/or data. The format of the packet may be defined by the OBEX session protocol.

The applications and profiles layer 318 may define multiple profiles describing multiple types of tasks. By following the profiles' procedures, developers may be sure that the applications created will work with any device that conforms to the BT specification.

A wireless device may have multiple radio interfaces that support multiple

RATs as defined by specific wireless communication protocols (e.g., Wi-Fi, BT, BLE, etc.). Accordingly, a wireless device may concurrently operate multiple radio interfaces corresponding to multiple RATs, such as BT and Wi-Fi.

A BT radio interface (e.g., a BT controller) located at the wireless device may implement a BT protocol that supports synchronous logical transport mechanisms that exist between a master device and a slave device. One example of a synchronous logical transport mechanism is an SCO logical transport. An SCO logical transport may provide a symmetric point-to-point link (an SCO link) between a master device and a slave device using time slots reserved for BT communications. An SCO link may not support data packet retransmission, however. Data packet retransmission may be useful in audio streaming and/or a voice use cases because a dropped audio or voice packet may reduce the quality of the user experience. Hence, using an SCO link may be impractical in audio streaming and/or voice use cases.

Additionally and/or alternatively, the BT protocol implemented by the BT radio interface may support an eSCO logical transport. An eSCO logical transport may provide a symmetric or asymmetric point-to-point link (an eSCO link) between a master device and a slave device using time slots reserved for BT communications, and a retransmission window following the reserved time slots. Because retransmissions may be facilitated using the retransmission window, an eSCO link may be useful in audio streaming and/or voice use cases because a dropped audio or voice packet may be retransmitted, and hence, the probability of properly receiving a dropped data packet may be increased.

In configurations when the slave device includes a microphone, certain time slots may be reserved for a BT microphone path between the master device and the slave device and different time slots may be reserved for a BT audio path between the master device and the slave device, such as when a voice call or video call is being relayed from a smart phone to a slave device (e.g., a pair of TWS earbuds). When the slave device includes a pair of TWS earbuds, a first eSCO link may be used for BT communications between a first TWS earbud and the master device, and a second eSCO link may be used for BT communications between the second TWS earbud and the master device.

In certain configurations, respective BT audio time slots in the first eSCO link and the second eSCO link may be used to carry BT audio data that is output at both the first TWS earbud and the second TWS earbud. However, BT microphone time slots associated with one of the first eSCO link or the second eSCO link (but not both) may be used to carry BT microphone packet data to the master device, and the BT microphone time slots from the other one of the first eSCO link or the second eSCO link may be muted (unused) in order to reduce power consumption at the master device and/or the slave device.

In other words, the unused BT microphone time slots in either the first eSCO link or the second eSCO link may be intentionally dropped by the master device. Even though the BT microphone time slots of one of the eSCO links are unused, the unused BT microphone time slots are still reserved for BT communications, and hence, may be unavailable for Wi-Fi communications, thereby reducing Wi-Fi throughput without increasing BT throughput.

During silent unreserved time slots (which are outside the retransmission window), a Wi-Fi radio interface (e.g., a WLAN controller) at the wireless device may share the same frequency bandwidth as the BT radio interface, and for established SCO and/or eSCO links, both the master device and the slave device may have knowledge of which time slots are reserved for BT and which time slots are unreserved for BT (e.g., unoccupied by BT packet data). Consequently, communications by the Wi-Fi radio interface may avoid interference with BT communications via the SCO link and/or eSCO link by using the unoccupied time slots for Wi-Fi communications.

The throughput for Wi-Fi communications may be reduced (e.g., exponentially reduced) as the number of consecutive time slots reserved for BT communications increases. In a first example in which no eSCO links are present at the master device, the throughput for Wi-Fi communications may be, e.g., 140 Mbps. In a second example in which a single eSCO link is present at the master device, the throughput for Wi-Fi communications may be, e.g., 70 Mbps. In a third example in which two eSCO links are present at the master device, the throughput for Wi-Fi communications may be, e.g., 30 Mbps.

Thus, there is a need for a mechanism that increases Wi-Fi throughput without reducing BT throughput in a multiple RAT wireless device.

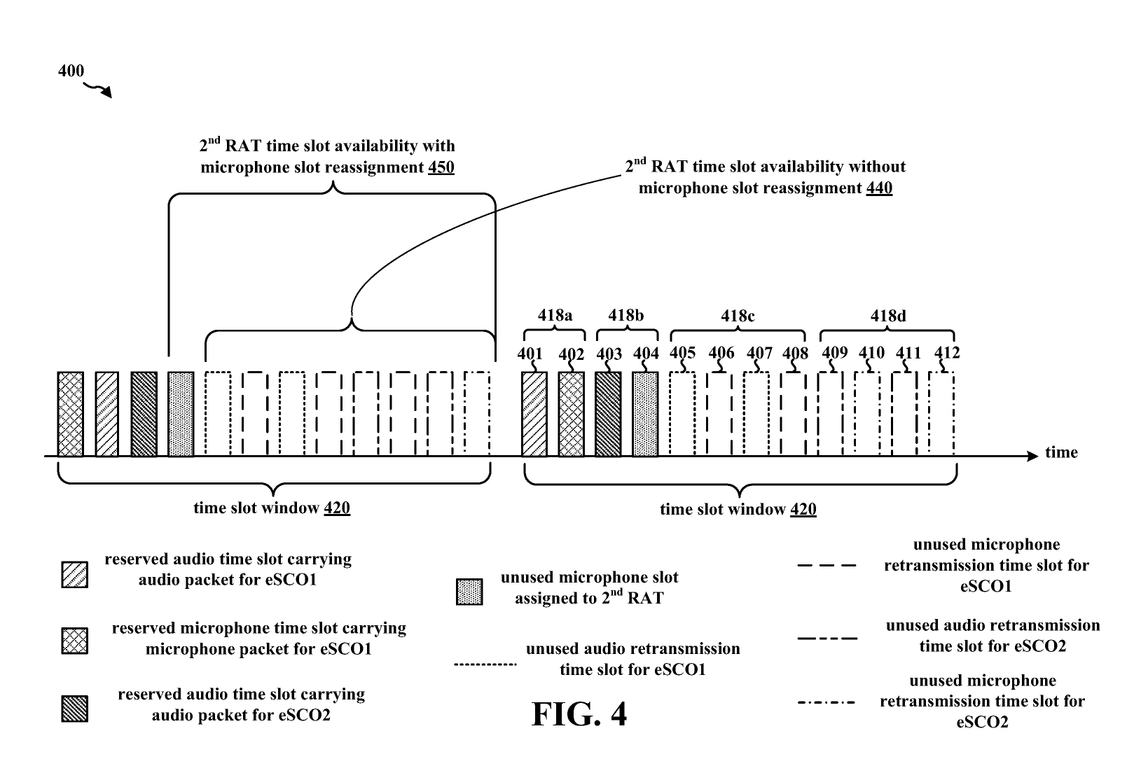

The present disclosure provides a solution by assigning the unused microphone time slots associated with one of the eSCO links for Wi-Fi communications when the slave device includes a pair of TWS earbuds, thereby increasing the number of consecutive time slots available for Wi-Fi communications without actually reducing BT throughput, e.g., as described below in connection with any of FIGS. 4-8.

FIG. 4 is a diagram 400 illustrating time slots that may be reserved by a master device (not shown) for a first eSCO link with a first slave device (not shown) and a second eSCO link with a second slave device (not shown) in accordance with certain aspects of the disclosure. In certain configurations, the master device (e.g., master device 102, 502, wireless device 200, apparatus 700/702′) may be in communication with a first slave device (e.g., slave device 108a, 108b, first slave device 504a, 750, second slave device 504b, 755), a second slave device (e.g., slave device 108a, 108b, first slave device 504a, 750, second slave device 504b, 755), and a third device (e.g., second device 112, the third device 506, 760). In certain configurations, the first slave device may include a first TWS earbud of a TWS earbud pair, and the second slave device may include a second TWS earbud of the TWS earbud pair. In certain configurations, the master device may communicate with the first slave device and the second slave device via a first RAT (e.g., BT, BLE, etc.) and the third device via a second RAT (e.g., Wi-Fi).

Within a time slot window 420, the master device may assign up to a maximum number (e.g., 2, 3, 4, 10, 12, 15, 100, etc.) of time slots for communications with the first slave device via the first eSCO link (e.g., eSCOl) and for communication with the second slave device via the second eSCO link (e.g., eSCO2). In the example illustrated in FIG. 4, each time slot window 420 includes a maximum of twelve time slots that may be assigned, reserved, and/or allocated for first RAT communications (e.g., BT, BLE, Zigbee®, etc.) via the first eSCO link and for the second eSCO link. Any of the time slots in a time slot window 420 that are not reserved for communications via the first RAT may be reassigned for communications via a second RAT (e.g., Wi-Fi) with a third device (e.g., second device 112, the third device 506, 760).

In FIG. 4, any packet data (e.g., either audio or microphone) that is carried by a time slot that is associated with the first eSCO link (e.g., time slots 401, 402, 405, 406, 407, 408) may be transmitted at a first frequency bandwidth associated with the first eSCO link, and any packet data (e.g., either audio or microphone) that is carried by a time slot that is associated with the second eSCO link (e.g., time slots 403, 404, 409, 410, 411, 412) may be transmitted at a second frequency bandwidth associated with the second eSCO link. In certain configurations, the first frequency bandwidth may be different and non-overlapping with the second frequency bandwidth. In certain other configurations, the first frequency bandwidth may be the same as the second frequency bandwidth. Setting the reserved time slots for the first eSCO link (e.g., time slots 401 and 402) and the second eSCO link (e.g., time slots 403 and 404) adjacent to each other in the time domain may maximizes overall air time for Wi-Fi throughput when retransmissions are not schedule in any of time slots 405, 406, 407, 408, 409, 410, 411, 412. An example time slot prioritization for each of the twelve time slots in a time slot window 420 in FIG. 4 is illustrated below in Table 1.

TABLE 1
Example Time Slot Prioritization

| Slot | Priority |
|---|---|
| 401-402 | eSCO1 reserved slots |
| 403-404 | eSCO2 reserved slots |
| 405-408 | eSCO1 retransmission slots |
| 409-412 | eSCO2 retransmission slots |

Each time slot window 420 may include a plurality of time slot groups 418a, 418b, 418c, 418d, each of which may be used for either the first eSCO link (e.g., time slot groups 418a, 418c) or the second eSCO link (e.g., time slot groups 418b, 418d).

The first time slot group 418a may include a first time slot 401 that may be reserved for an audio transmission via the first eSCO link, and a second time slot 402 that may be reserved for a microphone transmission via the first eSCO link. The second time slot group 418b may include a third time slot 403 that may be reserved for an audio transmission via the second eSCO link, and a fourth time slot 404 that may be reserved for a microphone transmission via the second eSCO link.

The third time slot group 418c may include a fifth time slot 405 and a seventh time slot 407 that may be used for audio retransmissions (e.g., a retransmission of an audio packet that was initially transmitted in the first time slot 401) via the first eSCO link, and a sixth time slot 406 and an eighth time slot 408 that may be used for microphone retransmissions (e.g., a retransmission of microphone packet that was initially transmitted in the second time slot 402) via the first eSCO link. When there are no retransmissions scheduled for the first eSCO link in the third time slot group 418c, the time slots 405, 406, 407, 408 in the third time slot group 418c may be used for the second eSCO link retransmissions (e.g., retransmissions of data packets initially transmitted in the second time slot group 418b).

The fourth time slot group 418d may include a ninth time slot 409 and an eleventh time slot 411 that may be used for audio retransmissions (e.g., a retransmission of an audio packet that was initially transmitted in the third time slot 403) via the first eSCO link, and a tenth time slot 410 and an twelfth time slot 412 that may be used for microphone retransmissions (e.g., a retransmission of microphone packet that was initially transmitted in the fourth time slot 404) via the first eSCO link.

To reduce power consumption, when the Handset Controller cannot support multiple microphone paths, an earbud's microphone path may be muted when it isn't the currently selected microphone.

When the first slave device includes a first TWS earbud in a TWS earbud pair and the second slave device includes a second TWS earbud in the TWS earbud pair, the speaker path (from the master device to a slave device) is replicated in the master device controller (e.g., short-range communication controller 252) and sent over both the first eSCO link and the second eSCO link.

Since the first eSCO link and the second eSCO link are independent, each of the first slave device and the second slave device may have a working microphone path to the master device. In the master device controller, a single microphone path (from either the first slave device or the second slave device to the master device) may be used. The master device may configure which microphone path to use. The other microphone path may be ignored (data dropped and acknowledged to minimize retransmissions).

Referring to FIG. 4, either the second time slot 402 or the fourth time slot 404 may be assigned to carry microphone packets from the TWS earbud pair to the master device. Microphone packets may not be sent via both the second time slot 402 (e.g., the first eSCO link) and the fourth time slot 404 (e.g., the second eSCO link) in order to reduce power consumption of the master device and/or one of the TWS earbuds. However, an audio packet may be sent via both the first eSCO link (e.g., the first time slot 401) and the second eSCO link (e.g., the third time slot 403) when audio output occurs at both the first slave device and the second slave device.

In order to increase the number of contiguous time slots that may be reassigned for communications via the second RAT, the master device may assign (e.g., reserve) the second time slot 402 for microphone packets instead of the fourth time slot 404.

By assigning the second time slot 402 instead of the fourth time slot 404, when data packets (e.g., audio and microphone) initially transmitted in the first time slot 401, the second time slot 402, and the third time slot 403 are not scheduled for retransmission using any of the time slots in the third time slot group 418c or the fourth time slot group 418d, there is an additional time slot (e.g., fourth time slot 404) that may be reassigned for communications via the second RAT.

In the example illustrated in FIG. 4, the time slot availability 440 for the second RAT when the fourth time slot 404 is not reassigned for the second RAT includes eight out of twelve time slots in a time slot window 420. However, the time slot availability 450 for the second RAT when the fourth time slot 404 is reassigned for the second RAT includes nine out of twelve time slots in a time slot window.

As mentioned above, each additional consecutive time slot that is reassigned to the second RAT (e.g., Wi-Fi) may exponentially increase the throughput for the second RAT. Consequently, using the reassignment mechanism described above in connection with FIG. 4, the throughput of the second RAT (e.g., Wi-Fi) may be increased by increasing the number of consecutive time slots available for the second RAT without reducing the throughput of the first RAT (e.g., because a microphone packet sent in the fourth time slot 404 may be dropped by the master device since the same microphone packet may be sent in the second time slot 402).

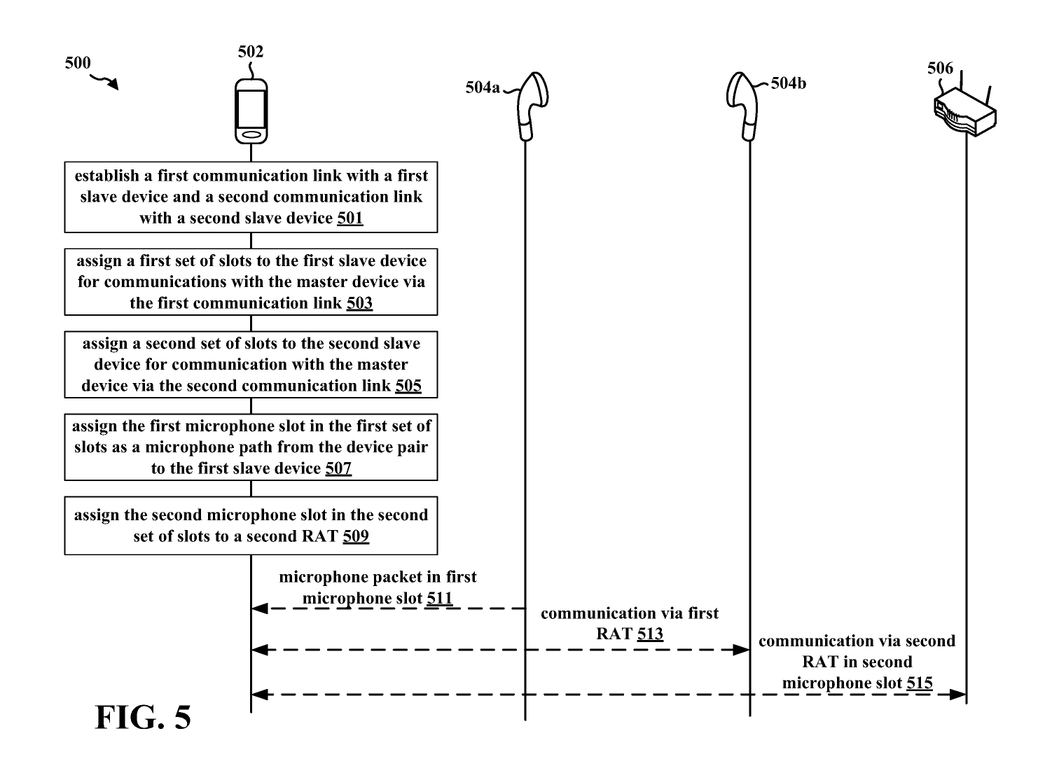

FIG. 5 is a data flow 500 that may be used by a master device 502 to increase the throughput of a first RAT in a multiple RAT system without reducing the throughput of a second RAT in accordance with certain aspects of the disclosure. The master device 502 may be in communication with a first slave device 504a via a first communication link (e.g., SCO link, eSCO link, etc.) and a second slave device 504b via a second communication link (e.g., SCO link, eSCO link, etc.). The first communication link and the second communication link may be associated with a first RAT (e.g., BT, BLE, etc.). The first slave device 504a and the second slave device 504b may form a device pair such as a pair of TWS earbuds. The master device 502 may also be in communication with a third device 506 via a third communication link that is associated with a second RAT (e.g., Wi-Fi) that is different than the first RAT.

The master device 502 may correspond to, e.g., the master device 102, the wireless device 200, the apparatus 702/702′. The first slave device 504a may correspond to, e.g., the slave device 108a, 108b, the first slave device 750, the second slave device 755. The second slave device 504b may correspond to, e.g., the slave device 108a, 108b, the first slave device 750, the second slave device 755. The third device 506 may include one or more devices, and correspond to, e.g., the second device 112, the third device 760. In FIG. 5, optional operations are illustrated with dashed lines.

In certain configurations, the master device 502 may establish (at 501) a first communication link with the first slave device 504a and a second communication link with a second slave device 504b. In certain aspects, the first communication link and the second communication link may be associated with a first RAT. For example, the master device 502 may implement the BT protocol stack 300 described above in connection with FIG. 3 and use the link manager 306 to establish and configure a first eSCO link with the first slave device 504a and a second eSCO link with the second slave device 504b.

In certain other configurations, the master device 502 may assign (at 503) a first set of slots (e.g., time slots 401, 402 in FIG. 4) to the first slave device 504a for communications with the master device 502 via the first communication link. In certain aspects, the first set of slots may include a first microphone slot (e.g., second time slot 402 in FIG. 4).

In certain other configurations, the master device 502 may assign (at 505) a second set of slots (e.g., time slots 403, 404) to the second slave device 504b for communication with the master device 502 via the second communication link. In certain aspects, the second set of slots may be located subsequent to the first set of slots in the time domain, and the second set of slots may include a second microphone slot (e.g., fourth time slot 404 in FIG. 4).

In certain other configurations, the master device 502 may assign (at 507) the first microphone slot (e.g., second time slot 402 in FIG. 4) in the first set of slots (e.g., time slots 401, 402 in FIG. 4) as a microphone path from the device pair 504a, 504b to the first slave device 504a.

In certain other configurations, the master device 502 may assign (at 509) the second microphone slot (e.g., the fourth time slot 404 in FIG. 4) in the second set of slots (e.g., time slots 403, 404 in FIG. 4) to a second RAT.

In certain other configurations, the master device 502 may receive (at 511) a voice packet in the first microphone slot (e.g., second time slot 402 in FIG. 4) from the first slave device 504a via the first RAT.

In certain other configurations, the master device 502 may communicate (at 513) with the second slave device 504b in at least one slot (e.g., third time slot 403 in FIG. 4) in the second set of slots (e.g., time slots 403, 404 in FIG. 4) via the first RAT. In certain aspects, the at least one slot may not include the second microphone slot (e.g., fourth time slot 404 in FIG. 4).

In certain other configurations, the master device 502 may communicate (at 515) with at least one third device 506 using a second RAT in the second microphone slot (e.g., fourth time slot 404 in FIG. 4) in the second set of slots (e.g., time slots 403, 404 in FIG. 4). In certain aspects, the second RAT (e.g., Wi-Fi) may be different than the first RAT (e.g., BT, BLE, Zigbee®, etc.).

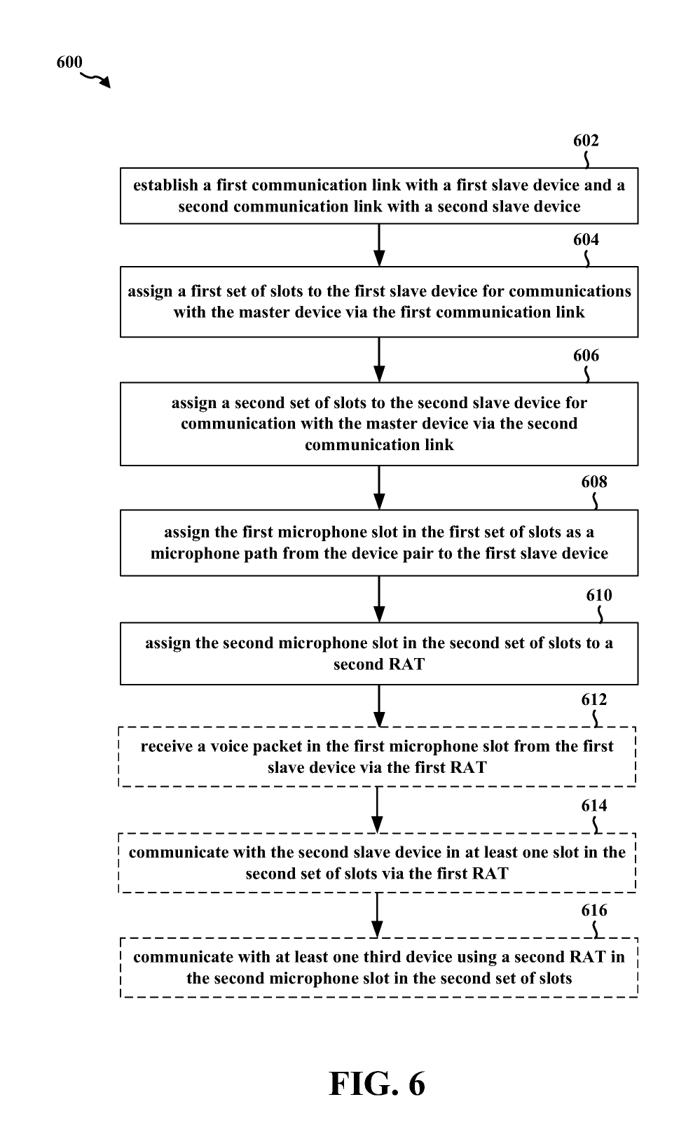

FIG. 6 is a flowchart 600 of a method of wireless communication. The method may be performed by a master device (e.g., the master device 102, the wireless device 200, the apparatus 702/702′). In FIG. 6, optional operations are illustrated with dashed lines.

At 602, the master device may establish a first communication link with a first slave device and a second communication link with a second slave device. In certain aspects, the first communication link and the second communication link may be associated with a first RAT. In certain other aspects, the first slave device and the second slave device may form a device pair. In certain other aspects, the first communication link includes a first eSCO link and the second communication link includes a second eSCO link. In certain other configurations, the first slave device may include a first wireless earbud of a wireless earbud pair and the second slave device may include a second wireless earbud of the wireless earbud pair. For example, with reference to FIGS. 3 and 5, the master device 502 may establish (at 501) a first communication link with the first slave device 504a and a second communication link with a second slave device 504b. In certain configurations, the master device 502 may implement the BT protocol stack 300 described above in connection with FIG. 3 and use the link manager 306 to establish (at 501) a first eSCO link with the first slave device 504a and a second eSCO link with the second slave device 504b.

At 604, the master device may assign a first set of slots to the first slave device for communications with the master device via the first communication link. In certain aspects, the first set of slots may include a first microphone slot. For example, referring to FIGS. 4 and 5, the master device 502 may assign (at 503) a first set of slots (e.g., time slots 401, 402 in FIG. 4) to the first slave device 504a for communications with the master device 502 via the first communication link. In certain aspects, the first set of slots may include a first microphone slot (e.g., second time slot 402 in FIG. 4).

At 606, the master device may assign a second set of slots to the second slave device for communication with the master device via the second communication link. In certain aspects, the second set of slots may be located subsequent to the first set of slots in the time domain. In certain other aspects, the second set of slots may include a second microphone slot. In certain other aspects, the second set of slots is directly adjacent to the first set of slots in the time domain. For example, with reference to FIGS. 4 and 5, the master device 502 may assign (at 505) a second set of slots (e.g., time slots 403, 404) to the second slave device 504b for communication with the master device 502 via the second communication link. In certain aspects, the second set of slots may be located subsequent to the first set of slots in the time domain, and the second set of slots may include a second microphone slot (e.g., fourth time slot 404 in FIG. 4).

At 608, the master device may assign the first microphone slot in the first set of slots as a microphone path from the device pair to the first slave device. For example, with reference to FIGS. 4 and 5, the master device 502 may assign (at 507) the first microphone slot (e.g., second time slot 402 in FIG. 4) in the first set of slots (e.g., time slots 401, 402 in FIG. 4) as a microphone path from the device pair 504a, 504b to the first slave device 504a.

At 610, the master device may assign the second microphone slot in the second set of slots to a second RAT. For example, with reference to FIGS. 4 and 5, the master device 502 may assign (at 509) the second microphone slot (e.g., the fourth time slot 404 in FIG. 4) in the second set of slots (e.g., time slots 403, 404 in FIG. 4) to a second RAT.

At 612, the master device may receive a voice packet in the first microphone slot from the first slave device via the first RAT. For example, referring to FIGS. 4 and 5, the master device 502 may receive (at 511) a voice packet in the first microphone slot (e.g., second time slot 402 in FIG. 4) from the first slave device 504a via the first RAT.

At 614, the master device may communicate with the second slave device in at least one slot in the second set of slots via the first RAT (e.g., using at least one of the antennas 235a, 235b, 235c, 235d and the short-range communication controller 252 in FIG. 2). In certain aspects, the at least one slot may not include the second microphone slot. For example, with reference to FIGS. 4 and 5, the master device 502 may communicate (at 513) with the second slave device 504b in at least one slot (e.g., third time slot 403 in FIG. 4) in the second set of slots (e.g., time slots 403, 404 in FIG. 4) via the first RAT. In certain aspects, the at least one slot may not include the second microphone slot (e.g., fourth time slot 404 in FIG. 4).

At 616, the master device may communicate with at least one third device using a second RAT in the second microphone slot in the second set of slots. In certain aspects, the second RAT may be different than the first RAT. In certain configurations, the first RAT may include either classic Bluetooth or Bluetooth Low Energy, and the second RAT may include Wi-Fi. For example, with reference to FIGS. 4 and 5, the master device 502 may communicate (at 515) with at least one third device 506 using a second RAT in the second microphone slot (e.g., fourth time slot 404 in FIG. 4) in the second set of slots (e.g., time slots 403, 404 in FIG. 4). In certain aspects, the second RAT (e.g., Wi-Fi) may be different than the first RAT (e.g., BT, BLE, Zigbee®, etc.).

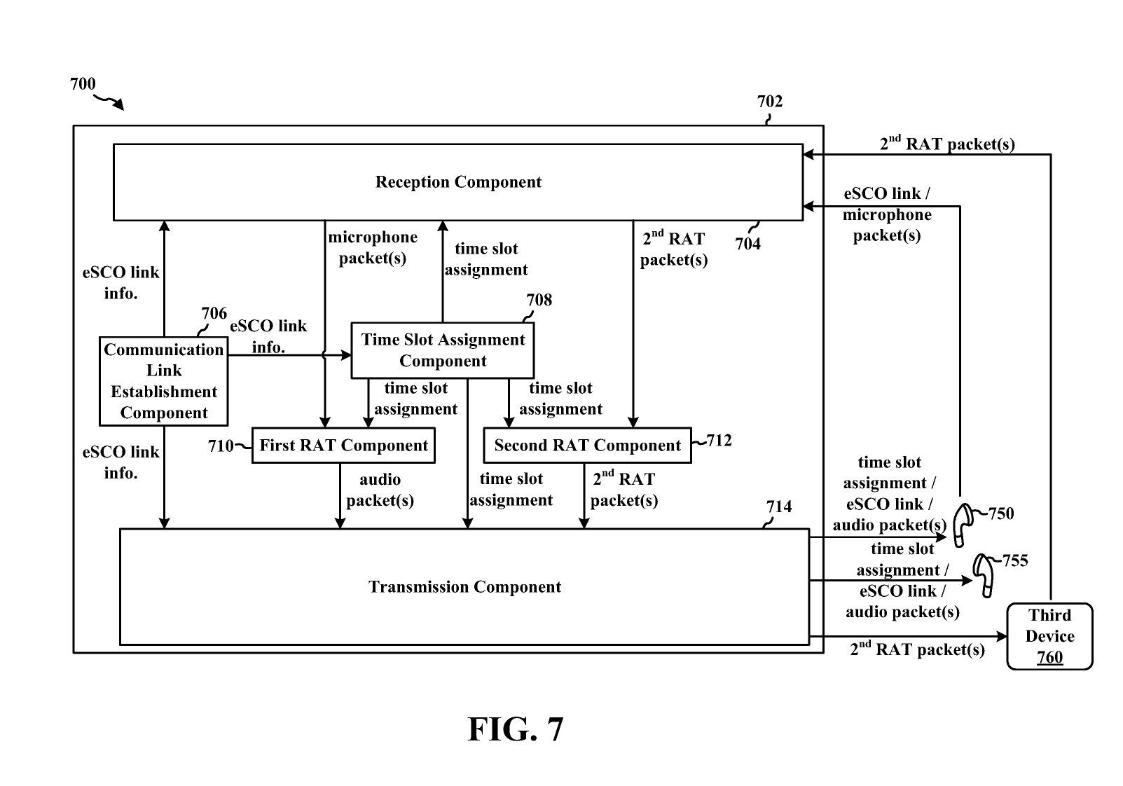

FIG. 7 is a conceptual data flow diagram 700 illustrating the data flow between different means/components in an exemplary apparatus 702. The apparatus may be a master device (e.g., the master device 102, 502, the wireless device 200, the apparatus 702′) in communication via a first RAT with a first slave device 750 (e.g., the slave device 108a, 108b, the first slave device 504a, the second slave device 504b), via the first RAT with a second slave device 755 (e.g., the slave device 108a, 108b, the first slave device 504a, the second slave device 504b), and via a second RAT with a third device 760 (e.g., the second device 112, the third device 506). The apparatus may include a reception component 704, a communication link establishment component 706, a time slot assignment component 708, a first RAT component 710, a second RAT component 712, and a transmission component 714.

In certain configurations, the communication link establishment component 706 may be configured to establish a first communication link with a first slave device and a second communication link with a second slave device. In certain aspects, the first communication link and the second communication link may be associated with a first RAT. In certain other aspects, the first slave device and the second slave device may form a device pair. In certain other aspects, the first communication link includes a first eSCO link and the second communication link includes a second eSCO link. In certain other configurations, the first slave device may include a first wireless earbud of a wireless earbud pair and the second slave device may include a second wireless earbud of the wireless earbud pair. The communication link establishment component 706 may be configured to send a signal associated with eSCO link information to one or more of the reception component 704, the time slot assignment component 708, and/or the transmission component 714.

In certain other configurations, the time slot assignment component 708 may be configured to assign a first set of slots to the first slave device 750 for communications with apparatus 702 via the first communication link. In certain aspects, the first set of slots may include a first microphone slot.

In certain other configurations, the time slot assignment component 708 may be configured to assign a second set of slots to the second slave device 755 for communication with the apparatus 702 via the second communication link. In certain aspects, the second set of slots may be located subsequent to the first set of slots in the time domain. In certain other aspects, the second set of slots may include a second microphone slot. In certain other aspects, the second set of slots is directly adjacent to the first set of slots in the time domain.

In certain other configurations, the time slot assignment component 708 may be configured to assign the first microphone slot in the first set of slots as a microphone path from the device pair to the first slave device 750.

In certain other configurations, the time slot assignment component 708 may be configured to assign the second microphone slot in the second set of slots to a second RAT. The time slot assignment component 708 may send a signal indicating time slot assignment information (e.g., including information associated with the first set of slots assigned to the first slave device 750, the second set of slots assigned to the second slave device 755, the first microphone slot assigned to the first slave device 750, and/or the second microphone slot being reassigned for communications via the second RAT) to one or more of the reception component 704, the first RAT component 710, the second RAT component 712, and/or the transmission component 714. The transmission component 714 may be configured to send a signal indicating the time slot assignment information to the first slave device 750 and/or the second slave device 755.

In certain configurations, the reception component 704 may be configured to receive a voice packet in the first microphone slot from the first slave device 750 via the first RAT. The reception component 704 may be configured to send a signal associated with the voice packet to the first RAT component 710. The first RAT component 710 may be configured to process the voice packet and send to a remote device (not shown).

In certain other configurations, the first RAT component 710 may be configured to receive a voice packet from the remote device (not shown), generate an audio packet based on the voice packet, and send the generated audio packet associated with the voice packet to the transmission component 714. The transmission component 714 may be configured to send the generated audio packet to the first slave device 750 and the second slave device 755. In certain configurations, the reception component 704 and/or the transmission component 714 may be configured to communicate with the second slave device 755 in at least one slot in the second set of slots via the first RAT. In certain aspects, the at least one slot may not include the second microphone slot.

In certain other configurations, the reception component 704 and/or the transmission component 714 may be configured to communicate with the third device 760 using a second RAT in the second microphone slot in the second set of slots. In certain aspects, the second RAT may be different than the first RAT. In certain configurations, the first RAT may include either classic Bluetooth or Bluetooth Low Energy, and the second RAT may include Wi-Fi.

The apparatus may include additional components that perform each of the blocks of the algorithm in the aforementioned flowchart of FIG. 6. As such, each block in the aforementioned flowchart of FIG. 6 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

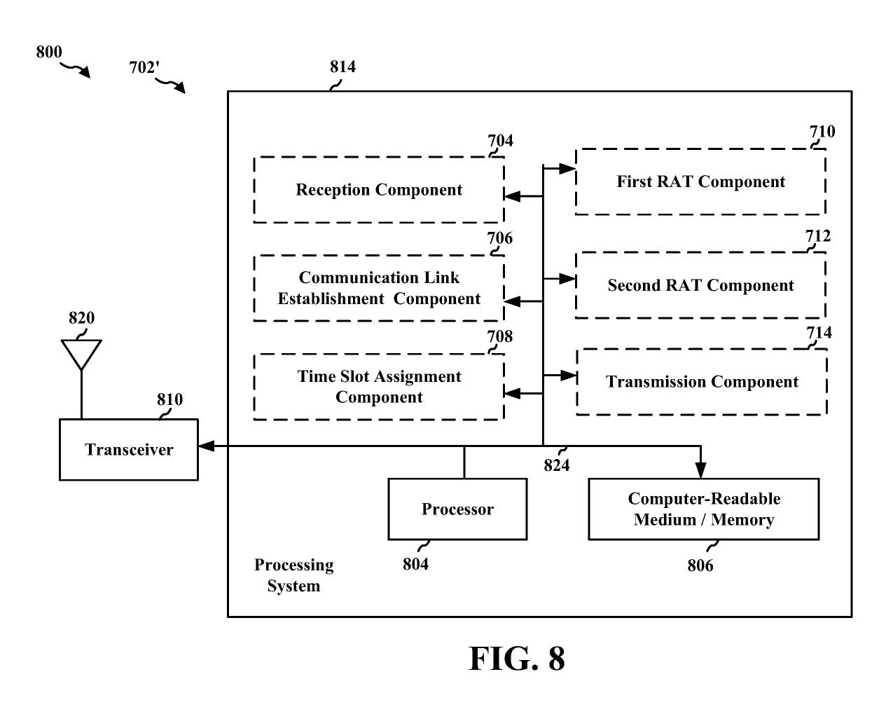

FIG. 8 is a diagram 800 illustrating an example of a hardware implementation for an apparatus 702′ employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware components, represented by the processor 804, the components 704, 706, 708, 710, 712, 714 and the computer-readable medium/memory 806. The bus 824 may also link various other circuits such as timing sources, peripherals, voltage regulators, and power management circuits, which are well known in the art, and therefore, will not be described any further.

The processing system 814 may be coupled to a transceiver 810. The transceiver 810 is coupled to one or more antennas 820. The transceiver 810 provides a means for communicating with various other apparatus over a transmission medium. The transceiver 810 receives a signal from the one or more antennas 820, extracts information from the received signal, and provides the extracted information to the processing system 814, specifically the reception component 704. In addition, the transceiver 810 receives information from the processing system 814, specifically the transmission component 714, and based on the received information, generates a signal to be applied to the one or more antennas 820. The processing system 814 includes a processor 804 coupled to a computer-readable medium/memory 806. The processor 804 is responsible for general processing, including the execution of software stored on the computer-readable medium/memory 806. The software, when executed by the processor 804, causes the processing system 814 to perform the various functions described supra for any particular apparatus. The computer-readable medium/memory 806 may also be used for storing data that is manipulated by the processor 804 when executing software. The processing system 814 further includes at least one of the components 704, 706, 708, 710, 712, 714. The components may be software components running in the processor 804, resident/stored in the computer readable medium/memory 806, one or more hardware components coupled to the processor 804, or some combination thereof.

In certain configurations, the apparatus 702/702′ for wireless communication may include means for establishing a first communication link with a first slave device and a second communication link with a second slave device. In certain aspects, the first communication link and the second communication link may be associated with a first RAT. In certain other aspects, the first slave device and the second slave device may form a device pair. In certain other aspects, the first communication link includes a first eSCO link and the second communication link includes a second eSCO link. In certain other configurations, the first slave device may include a first wireless earbud of a wireless earbud pair and the second slave device may include a second wireless earbud of the wireless earbud pair. In certain other configurations, the apparatus 702/702′ for wireless communication may include means for assigning a first set of slots to the first slave device for communications with the master device via the first communication link. In certain aspects, the first set of slots may include a first microphone slot. In certain other configurations, the apparatus 702/702′ for wireless communication may include means for assigning a second set of slots to the second slave device for communication with the master device via the second communication link. In certain aspects, the second set of slots may be located subsequent to the first set of slots in the time domain. In certain other aspects, the second set of slots may include a second microphone slot. In certain other aspects, the second set of slots is directly adjacent to the first set of slots in the time domain. In certain other configurations, the apparatus 702/702′ for wireless communication may include means for assigning the first microphone slot in the first set of slots as a microphone path from the device pair to the first slave device. In certain other configurations, the apparatus 702/702′ for wireless communication may include means for assigning the second microphone slot in the second set of slots to a second RAT. In certain other configurations, the apparatus 702/702′ for wireless communication may include means for receiving a voice packet in the first microphone slot from the first slave device via the first RAT. In certain other configurations, the apparatus 702/702′ for wireless communication may include means for communicating with the second slave device in at least one slot in the second set of slots via the first RAT. In certain aspects, the at least one slot may not include the second microphone slot. In certain other configurations, the apparatus 702/702′ for wireless communication may include means for communicating with at least one third device using a second RAT in the second microphone slot in the second set of slots. In certain aspects, the second RAT may be different than the first RAT. In certain configurations, the first RAT may include either classic Bluetooth or Bluetooth Low Energy, and the second RAT may include Wi-Fi. The aforementioned means may be the processor(s) 202, the radio 230, the MMU 240, the WLAN controller 250, short-range communication controller 252, one or more of the aforementioned components of the apparatus 702 and/or the processing system 814 of the apparatus 702′ configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to the various aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a master device, comprising:
establishing a first communication link with a first slave device and a second communication link with a second slave device, the first communication link and the second communication link being associated with a first radio access technology (RAT), and the first slave device and the second slave device forming a device pair;
assigning a first set of slots to the first slave device for communications with the master device via the first communication link, the first set of slots including a first microphone slot;
assigning a second set of slots to the second slave device for communication with the master device via the second communication link, the second set of slots being located subsequent to the first set of slots in a time domain, and the second set of slots including a second microphone slot;
assigning the first microphone slot in the first set of slots as a microphone path from the device pair to the first slave device;
assigning the second microphone slot in the second set of slots to a second RAT; and
communicating with at least one third device using the second RAT in the second microphone slot in the second set of slots, the second RAT being different than the first RAT.

2. The method of claim 1, further comprising:
receiving a voice packet in the first microphone slot from the first slave device via the first RAT; and
communicating with the second slave device in at least one slot in the second set of slots via the first RAT, the at least one slot not including the second microphone slot.

3. The method of claim 1, wherein the first RAT includes either classic Bluetooth or Bluetooth Low Energy, and the second RAT includes Wi-Fi.

4. The method of claim 1, wherein the first communication link includes a first extended synchronous connection orientated (eSCO) link and the second communication link includes a second eSCO link.

5. The method of claim 4, wherein the first slave device includes a first wireless earbud of a wireless earbud pair and the second slave device includes a second wireless earbud of the wireless earbud pair.

6. The method of claim 1, wherein the second set of slots is directly adjacent to the first set of slots in the time domain.

7. An apparatus for wireless communication of a master device, comprising:
means for establishing a first communication link with a first slave device and a second communication link with a second slave device, the first communication link and the second communication link being associated with a first radio access technology (RAT), and the first slave device and the second slave device forming a device pair;
means for assigning a first set of slots to the first slave device for communications with the master device via the first communication link, the first set of slots including a first microphone slot;
means for assigning a second set of slots to the second slave device for communication with the master device via the second communication link, the second set of slots being located subsequent to the first set of slots in a time domain, and the second set of slots including a second microphone slot;
means for assigning the first microphone slot in the first set of slots as a microphone path from the device pair to the first slave device;
means for assigning the second microphone slot in the second set of slots to a second RAT; and
means for communicating with at least one third device using the second RAT in the second microphone slot in the second set of slots, the second RAT being different than the first RAT.

8. The apparatus of claim 7, further comprising:
means for receiving a voice packet in the first microphone slot from the first slave device via the first RAT; and
means for communicating with the second slave device in at least one slot in the second set of slots via the first RAT, the at least one slot not including the second microphone slot.

9. The apparatus of claim 7, wherein the first RAT includes either classic Bluetooth or Bluetooth Low Energy, and the second RAT includes Wi-Fi.

10. The apparatus of claim 7, wherein the first communication link includes a first extended synchronous connection orientated (eSCO) link and the second communication link includes a second eSCO link.

11. The apparatus of claim 10, wherein the first slave device includes a first wireless earbud of a wireless earbud pair and the second slave device includes a second wireless earbud of the wireless earbud pair.

12. The apparatus of claim 7, wherein the second set of slots is directly adjacent to the first set of slots in the time domain.

13. An apparatus for wireless communication of a master device, comprising:
a memory; and
at least one processor coupled to the memory and configured to:
establish a first communication link with a first slave device and a second communication link with a second slave device, the first communication link and the second communication link being associated with a first radio access technology (RAT), and the first slave device and the second slave device forming a device pair;
assign a first set of slots to the first slave device for communications with the master device via the first communication link, the first set of slots including a first microphone slot;
assign a second set of slots to the second slave device for communication with the master device via the second communication link, the second set of slots being located subsequent to the first set of slots in a time domain, and the second set of slots including a second microphone slot;
assign the first microphone slot in the first set of slots as a microphone path from the device pair to the first slave device;
assign the second microphone slot in the second set of slots to a second RAT; and
communicate with at least one third device using the second RAT in the second microphone slot in the second set of slots, the second RAT being different than the first RAT.

14. The apparatus of claim 13, wherein the at least one processor is further configured to:
receive a voice packet in the first microphone slot from the first slave device via the first RAT; and
communicate with the second slave device in at least one slot in the second set of slots via the first RAT, the at least one slot not including the second microphone slot.

15. The apparatus of claim 13, wherein the first RAT includes either classic Bluetooth or Bluetooth Low Energy, and the second RAT includes Wi-Fi.

16. The apparatus of claim 13, wherein the first communication link includes a first extended synchronous connection orientated (eSCO) link and the second communication link includes a second eSCO link.

17. The apparatus of claim 16, wherein the first slave device includes a first wireless earbud of a wireless earbud pair and the second slave device includes a second wireless earbud of the wireless earbud pair.

18. The apparatus of claim 13, wherein the second set of slots is directly adjacent to the first set of slots in the time domain.

19. A computer-readable medium storing computer executable code for a master device, comprising code to:
establish a first communication link with a first slave device and a second communication link with a second slave device, the first communication link and the second communication link being associated with a first radio access technology (RAT), and the first slave device and the second slave device forming a device pair;
assign a first set of slots to the first slave device for communications with the master device via the first communication link, the first set of slots including a first microphone slot;
assign a second set of slots to the second slave device for communication with the master device via the second communication link, the second set of slots being located subsequent to the first set of slots in the time domain, and the second set of slots including a second microphone slot;
assign the first microphone slot in the first set of slots as a microphone path from the device pair to the first slave device;
assign the second microphone slot in the second set of slots to a second RAT; and
communicate with at least one third device using a second RAT in the second microphone slot in the second set of slots, the second RAT being different than the first RAT.

20. The computer-readable medium of claim 19, further comprising code to:
receive a voice packet in the first microphone slot from the first slave device via the first RAT; and
communicate with the second slave device in at least one slot in the second set of slots via the first RAT, the at least one slot not including the second microphone slot.

21. The computer-readable medium of claim 19, wherein the first RAT includes either classic Bluetooth or Bluetooth Low Energy, and the second RAT includes Wi-Fi.

22. The computer-readable medium of claim 19, wherein the first communication link includes a first extended synchronous connection orientated (eSCO) link and the second communication link includes a second eSCO link.

23. The computer-readable medium of claim 22, wherein the first slave device includes a first wireless earbud of a wireless earbud pair and the second slave device includes a second wireless earbud of the wireless earbud pair.

24. The computer-readable medium of claim 19, wherein the second set of slots is directly adjacent to the first set of slots in the time domain.
